(19) United States
(12) Patent Application Publication
(10) Pub. No.: US 2006/0086226 A1
(43) Pub. Date: Apr. 27, 2006

(54) Sheet cutting device

(76) Inventors: Masahiro Kaneko, Tokyo (JP); Toshio Shida, Tokyo (JP); Hiroyuki Wakabayashi, Tokyo (JP)

Correspondence Address: CANTOR COLBURN LLP, 55 Griffin Road South, Bloomfield, CT, 06002, US

(21) Appl. No.: 11/181,269

(22) Filed: Jul. 14, 2005

(30) Foreign Application Priority Data
Oct. 21, 2004 (JP) JP2004-306485

(51) Int. Cl. B26D 1/06

(52) U.S. Cl. 83/638

(57) ABSTRACT

A sheet cutting device, including a cutter blade to cut a bundle of sheets by moving at a slant whose component is a compound of moving perpendicular to the surface of the bundle of sheets and simultaneously parallel to the surface of the bundle of sheets, a supporting member to support the bundle of sheets for cutting, wherein the supporting member includes a supporting surface to support the bundle of sheets and an edge section perpendicular to the supporting surface; and a pressing member to press the bundle of sheets on the supporting member, wherein the cutter blade moves along the edge section and protrudes beyond the supporting surface so that the cutter blade cuts through the whole bundle of sheets, and wherein the clearance between the edge section and the cutter blade is 0.0 to 0.5 mm.

This application is based on Japanese Patent Application No. 2004-306485 filed on Oct. 21, 2004 in Japanese Patent Office, the entire content of which is hereby incorporated by reference.

### BACKGROUND OF THE INVENTION

The present invention relates to a sheet cutting device which cuts a plurality of sheets, and in particular, to a sheet cutting device which can be installed in an image forming system, such as a copy machine, a printer, a facsimile, and a compounded apparatus which includes more than two functions of the above functions.

As the sheet post-processing device which is installed in a system of the image forming apparatus, apparatuses have been developed which produce booklets via bundling a plurality of sheets. In most of the sheet post-processing devices, the bundles of sheets are folded at their central sections, then bound at the central sections, after which, facing sections to the bound sections, that is, the edges opposite the bound edges are cut by the sheet cutting device, resulting in a uniformly edged booklet.

Since the sheet cutting device to be installed in the sheet post-processing device is structured as part of the image forming apparatus installed in copy centers or offices, it must be small-sized, as well as working with low power consumption, and further, it is necessary that the function to produce uniformly edged booklets is always maintained. If the cut edges are uneven, or uncut portions remain, the booklet cannot be opened smoothly, which is of course a major problem.

On the other hand, a sheet cutting apparatus used in the production process of a great number of the same booklets, such as printed matter, is a large-scale operation and driven by great electric power, accordingly, such sheet cutting apparatus need only be good enough to exhibit high cutting performance. However, concerning the sheet cutting device used as a part of the image forming apparatus, the essential condition is that the device is operable with small electric power, and is small in overall size. Therefore, design in ingenuity is necessary to perform functions beyond the large-scale sheet cutting apparatus.
Japanese Unexamined Patent Publication No. 2003-136471 (hereinafter referred to as the Patent Document 1) discloses a sheet cutting device wherein the sheets are trimmed by a cutter which is pressed against the sheet surface at a slant, as the sheet cutting device which can be used in a business machine.

In the sheet cutting device described in Patent the Document 1, in order to cut the sheets, the cutter is pressed at a slant onto the sheets placed on a cutting table. In this cutting method, the component of force is parallel to the surfaces of the sheets, therefore, the sheets are liable to be more misaligned during the cutting process.

In order to cut the bundle of sheets in such a manner that the edges of the bundle of sheets are flat, the above-described misalignment parallel to the surface of the sheets must be prevented. In the case of the Patent Document 1, the above-described misalignment is often generated because of the slanted movement of the cutter. For this purpose, the bundle of sheets are pressed by a force of about 1 ton. However, when the bundle of sheets are cut, while being pressed by such great force, the pressure mark due to the pressure deformation is generated on the edges of the sheets, which is a drawback.

The generation of the pressure mark will now be explained referring to FIG. 1.

After bundles of sheets SS are sandwiched between supporting plate ST and pressure member PM, bundle of sheets SS is pressed by force F of pressing member PM. Since pressing force F is about 1 ton, the sheets are bent at boundary section SC which is between edge section SA being a tear-off section and also a non-forced section and pressed section SB (See FIG. 1).

The sheets are cut away at edge section SA from boundary section SC. After the cutting procedure, when edge section SA being a trimmed section is long, pressure marks are generated near the cut edges of bundle of sheets SS, which are due to bending of boundary section SC. Therefore, the edges of bundle of sheets SS are misaligned, which decrease the appearance of the bundle.

### SUMMARY

There thus exists a need to overcome the above problem.

The present invention provides,

a sheet cutting device, including:

a cutter blade to cut a bundle of sheets by moving at a slant whose component is a compound of moving perpendicular to the surface of the bundle of sheets and simultaneously parallel to the surface of the bundle of sheets,

a supporting member to support the bundle of sheets for cutting, wherein the supporting member includes a supporting surface to support the bundle of sheets and an edge section perpendicular to the supporting surface; and

a pressing member to press the bundle of sheets on the supporting member,

wherein the cutter blade moves along the edge section and protrudes beyond the supporting surface so that the cutter blade cuts through the whole bundle of sheets, and

wherein the clearance between the edge section and the cutter blade is 0.0 to 0.5 mm.

### BRIEF DESCRIPTION OF THE DRAWINGS

FIG. 1 is a drawing to illustrate generation of the pressure marks.

FIG. 2 shows the structure of the sheet cutting device relating to the embodiment of the present invention.

FIG. 3 is a cross sectional view of the cutting section.

FIG. 4 is an enlarged cross sectional view of the cutting section.

FIG. 5 is an enlarged cross sectional view of a cutter unit supporting section.

### DETAILED DESCRIPTION OF THE PREFERRED EMBODIMENTS

The embodiments of the present invention will now be described below referring to the drawings, however, the present invention is not limited to the described embodiments.

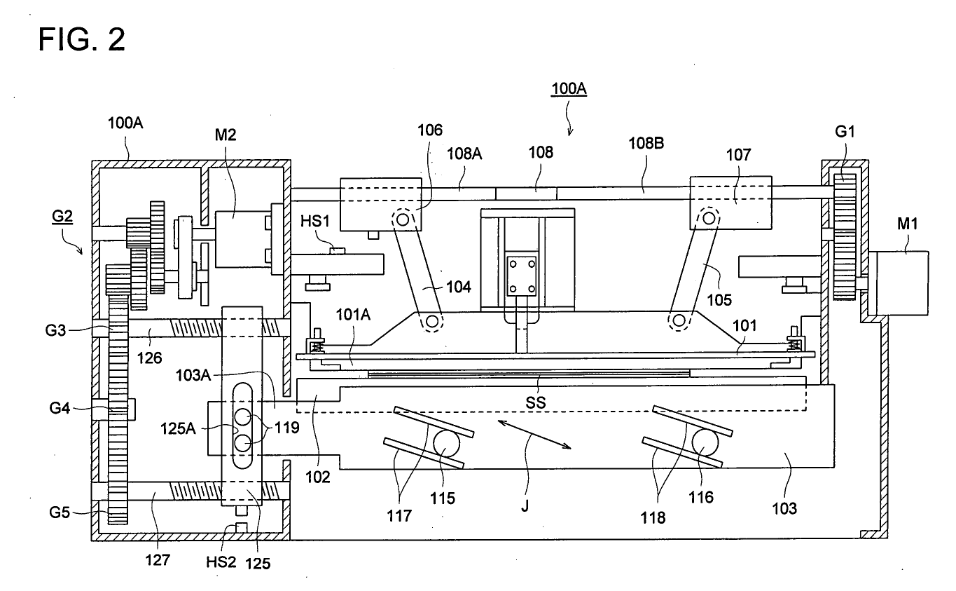

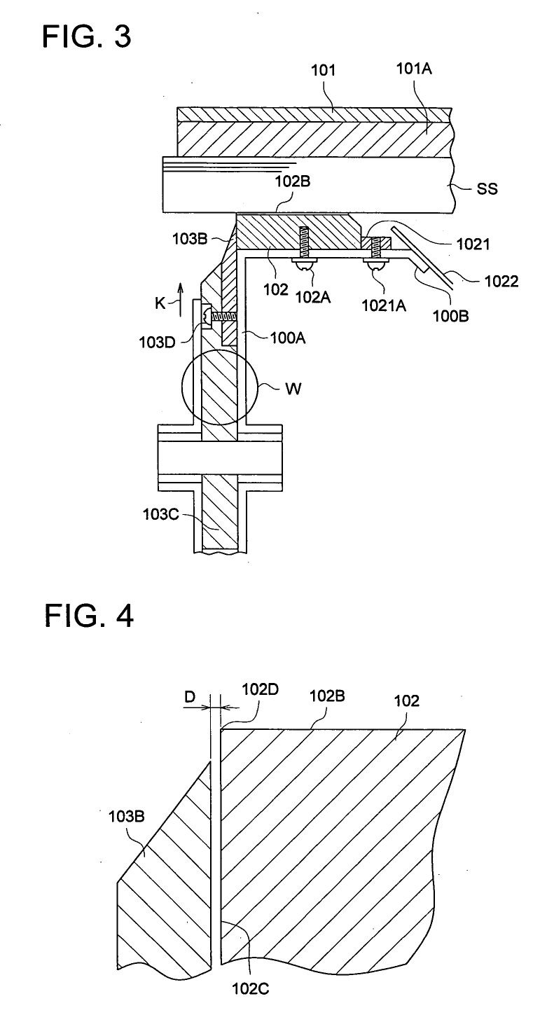

FIG. 2 is a front view of the sheet cutting device, while FIG. 3 is a cross sectional view of the cutting section.

On the upper section of sheet cutting device 100, shaft 108 supported by frame 100A of sheet cutting section 100 is mounted (see FIG. 2). Male screws 108A and 108B, which rotate in opposite direction, are mounted on shaft 108, and further male feed screw 108A is engaged within female screw unit 106, while male screw 108B is engaged within female screw unit 107.

Vertically movable pressing member 101 and female screw units 106 and 107 are connected by connecting arms 104 and 105. That is, the upper end of connecting arm 104 is supported by female screw unit 106, while the lower end of connecting arm 104 is supported by the left end of pressing member 101. Further, the upper end of connecting arm 105 is supported by female screw unit 107, and the lower end of connecting arm 105 is supported by the right end of pressing member 101. Since shaft 108 is engaged with motor M2 via gear G1, when motor M2 rotates, female units 106 and 107 move in opposite directions. And thereby, connecting arms 104 and 105 change their slopes, and pressing member 101 is driven vertically, remaining parallel to the axis of shaft 108.

As described above, motor M2, female screw units 106 and 107, and connecting arms 104 and 105 structure a pressing member driving mechanism which drives pressing member 101 vertically.

Pressing member 101 includes cutter receiving member 101A, and bundled sheets SS are gripped and secured between cutter receiving member 101A and supporting plate 102. Since pressing member 101 is driven by a driving mechanism including male screws 108A and 108B under a greatly reduced gear ratio, pressing member 101 presses bundled sheets SS under high pressure, being about 1 ton.

Rollers 115 and 116 are fixed on cutter unit 103 whose top edge is the blade, and guided by guide members 117 and 118, both of which are slanted to the right. Guide members 117 and 118 are firmly fixed to frame 100A.

Cutter driving member 125 is driven in the horizontal direction via male screws 126 and 127. Male screws 126 and 127 are driven by motor M3 via gears G2-G5. Further, vertical slot 125A is formed on cutter driving member 125, and engages two pins 119 which are fixed on end 103A of cutter unit 103.

The driving mechanism of cutter unit 103 is composed of motor M3, gears G2-G5, male screws 126 and 127, and cutter driving member 125, whereby cutter unit 103 is driven in the horizontal direction. Cutter unit 103 is raised and lowered by guide members 117 and 118 at an angle in arrowed direction J

Next, the operation of cutting device 100 will be explained.

In standby status, pressing member 101 is at its upper limit, being the home position.

When bundled sheets SS are introduced into cutting device 100, motor M2 is activated so that female screw units 106 and 107 move, and thereby, pressing member 101 is lowered. Under the condition that receiving member 101A presses bundled sheets SS, pressing member 101 stops lowering.

When the plurality of stacked bundled sheets SS are trimmed, in order to prevent generation of their misalignment due to horizontal force, pressing member 101 evenly presses the whole surface of bundled sheets SS with great force so that they are not misaligned by the horizontal force generated by cutter unit 103.

When bundled sheets SS have been completely pressed, motor M3 is activated which moves cutter unit 103 toward the upper left, shown by arrow J. By this movement of cutter unit 103, cutter unit 103 goes up from the initial position as shown in FIG. 3, and cutter blade 103B is projected from top surface 102B of supporting plate 102 to trim bundled sheets SS. Since the cutting action of cutter blade 103B (see FIG. 3) is performed via sliding of cutter blade 103B, the cutting action can be performed with a relatively small driving force. In addition, even when a large number of the sheets are cut, the driving force does not change, though the stroke length of the cutter does change.

After all of the stacked bundles are cut, the cutting edge of cutter blade 103B comes into contact with cutter receiving member 101A, whereby, the resistance against the driving force of cutter unit 103 increases. The controller detects the increased current loaded in motor M2, caused due to the resistance. That is, it detects the increase of motor driving current, and deactivates driving motor M2. The total bundles included in bundled sheets SS are cut in this manner.

After the edges of the sheets are cut, motor M1 is reactivated, and rotated in the opposite direction of the above procedure, to retract pressing member 101. Further, motor M2 is activated to lower cutter unit 103 to the predetermined position in the lower right of FIG. 2, and cutter unit 103 finally stops at the lower limit position, being the home position.

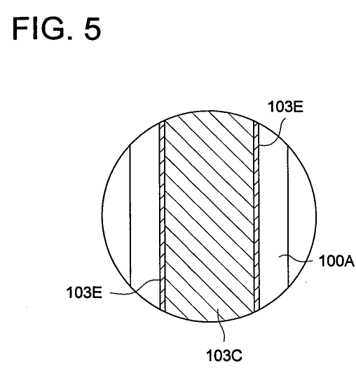

Supporting plate 102, which supports bundled sheets SS at the cutting position, is formed of resins, such as polypropylene and polyoxymethylene, and fixed into frame 100A with plural screws 102A, at several points in the longitudinal direction (perpendicular to the printed surface of FIG. 3) into supporting plate 102. The position of supporting plate 102 is secured by block 1021 from the sheet conveyance direction. Block 1021 is fixed with screw 1021A on frame 100A. Supporting plate 102 includes top surface 102B to support bundled sheets SS, and edge 102C generally perpendicular to top surface 102B and facing cutter blade 103B (see FIG. 4), and the position of edge 102C is precisely secured by block 1021.

Numeral 1022, being an entrance guide for bundled sheets SS, is formed of an elastic film, such as polyethylene terephthalate, and is adhered onto slope section 100B formed on frame 100A.

Cutter blade 103B is fixed onto cutter holder 103C by screws 103D. Just like supporting plate 102, cutter blade 103B is secured by plural screws 103D, at several points in the longitudinal direction (perpendicular to the printed surface of FIG. 3) of cutter blade 103B. Cutter unit 103, composed of cutter blade 103B and cutter holder 103C, moves upward as shown by arrow K to cut bundled sheets SS.

Bundled sheets SS are pressed onto supporting plate 102 by pressing member 101.

FIG. 3 shows the condition of cutter blade 103B being at the initial position. Cutter blade 103B goes up from the position of FIG. 3, and protrudes beyond top surface 102B so that all bundled sheets SS are assuredly cut.

In addition, as shown in FIG. 5 (which is an enlarged cross sectional view of circle W in FIG. 3), film sheets 103E, formed of high-pressure polyethylene film, are sandwiched between cutter holder 103C and frame 100A, and thereby, cutter unit 103 moves smoothly in the vertical direction.

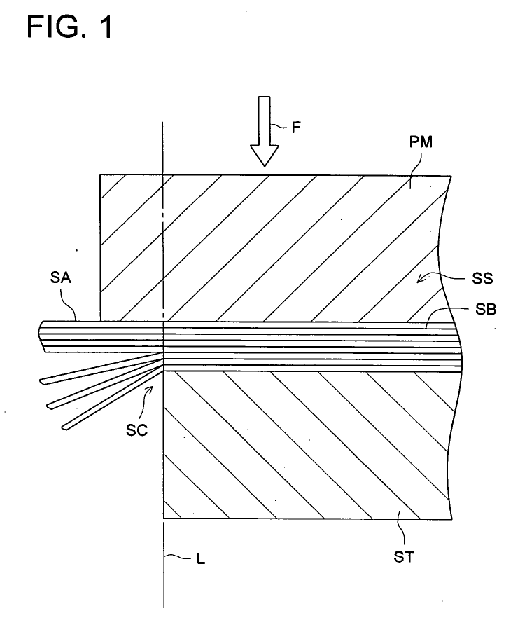

FIG. 4 is an enlarged cross sectional view of the cutting section. Clearance D between cutter blade 103B and edge 102C of supporting plate 102 is set less than 0.5 mm. By setting clearance D to be less than 0.5 mm, it is possible to prevent generation of pressure marks on the edges of bundled sheets SS which have been cut, which will now be explained further referring to FIG. 1.

By setting clearance D to be less than 0.5 mm, it is possible to cut bundled sheets SS at the position just on boundary section SC or at the position shown by dotted line L which is almost adjacent to boundary section SC. Consequently, pressure marks due to deformation of the sheet surface caused by the high pressure cannot be generated on the edges of bundled sheets SS, which have been cut.

AS described above, in order to totally prevent generation of pressure marks on the edge of bundled sheets SS which have been cut, it is preferable that cutter blade 103B is directly brought into contact with edge 102C of supporting plate 102, that is, cutter blade 103B is raised while clearance D is zero, and cutter blade 103B is driven to cut bundled sheets SS. Further, it is preferable that right angle 102D, formed by top surface 102B and edge 102C, is not rounded, but sharp edged. Even when right angle 102D is round shaped, the curvature radius must be to be less than 0.5 mm, by which the generation of the pressure marks is exactly prevented.

According to the present invention, bundled from dozens of sheets to multiple-thousand sheets which have the high grade edge can be formed. And the generation of the pressure marks which is easy to generate in the vicinity of the cutting position is exactly prevented.

What is claimed is:

1. A sheet cutting device, comprising:
a cutter blade to cut a bundle of sheets by moving at a slant whose component is a compound of moving perpendicular to a surface of the bundle of sheets and simultaneously parallel to the surface of the bundle of sheets, and
a supporting member to support the bundle of sheets for cutting, wherein the supporting member includes a supporting surface to support the bundle of sheets and an edge section perpendicular to the supporting surface;
wherein the cutter blade moves along the edge section and protrudes beyond the supporting surface so that the cutter blade cuts through the whole bundle of sheets, and
wherein a clearance between the edge section and the cutter blade is 0.0 to 0.5 mm.

2. The sheet cutting device in claim 1, further comprising a pressing section to press the bundle of sheets on the supporting member.

3. The sheet cutting device in claim 1, wherein the cutter blade moves while touching to the edge section and cuts the bundle of sheets.

4. The sheet cutting device in claim 1, wherein the supporting member is formed of resin.

5. The sheet cutting device in claim 1, wherein a right angle section formed by the supporting surface and the edge section is round shaped, and curvature radius of the right angle section is equal to or less than 0.5 mm.

6. The sheet cutting device in claim 1, wherein the right angle section formed by the supporting surface and the edge section is edgy.

7. The sheet cutting device in claim 1, further comprising a cutter holder to support the cutter blade.

8. The sheet cutting device in claim 7, wherein the cutter holder includes a resin film between the cutter blade and the edge section of the supporting member.

9. The sheet cutting device in claim 8, wherein the resin film is a high-pressure polyethylene film.

10. The sheet cutting device in claim 1, the cutter blade is longitudinal.

11. The sheet cutting device in claim 1, further comprising a cutter driving section to raise the cutter blade upwardly.

12. The sheet cutting device in claim 2, wherein the pressing section receives the cutter blade when the cutter blade cuts the bundle of sheets.

13. The sheet cutting device in claim 12, wherein the pressing section moves downwardly when the pressing section presses the bundle of sheets.

14. A sheet post-processing device, comprising the sheet cutting device in claim 1.

15. An image forming system, comprising the sheet post-processing device in claim 1.
